(19) United States
(12) Patent Application Publication
(10) Pub. No.: US 2009/0094408 A1
(43) Pub. Date: Apr. 9, 2009

(54) MEMORY WRITING DEVICE

(76) Inventor: Masataka Osaka, Osaka (JP)

Correspondence Address: MCDERMOTT WILL & EMERY LLP, 600 13TH STREET, NW, WASHINGTON, DC, 20005-3096, US

(21) Appl. No.: 11/995,892

(22) PCT Filed: Dec. 15, 2005
(86) PCT No.: PCT/JP2005/023068

§ 371 Date: Jan. 16, 2008

(30) Foreign Application Priority Data
Jul. 29, 2005 (JP) 2005-221993

(51) Int. Cl. G06F 12/02; G06F 15/177

(52) U.S. Cl. 711/103; 713/2; 711/E12.008

(57) ABSTRACT

After power-on, the start-up of a CPU 112 is suppressed by a microcomputer start-up suppressing/DMA start-up controlling device 101. Before the start-up of the CPU 112, a program read by a memory card I/F 103 is written in a writable ROM 105 by a DMA controlling device 102. After the start-up of the CPU 112, the CPU 112 executes the program written in the writable ROM 105.

### TECHNICAL FIELD

The present invention relates to a memory writing device for downloading programs to a blank writable ROM, which is mounted on the substrate during the manufacturing process.

### BACKGROUND ART

Conventionally, in order to download a program to a blank writable ROM, which is mounted on the substrate in the manufacturing stage, a dedicated downloading contact is provided on the substrate, whereby necessary information is written to the writable ROM via the contact.

Another approach is to write necessary information to the writable ROM by means of a special program device and then mount the writable ROM on the substrate.

Moreover, Patent Document 1 discloses a method for booting from an NAND-type memory device, wherein programs are provided therein in advance for devices connected thereto.

Patent Document 1: Japanese Laid-Open Patent Publication No. 2003-271391

### DISCLOSURE OF THE INVENTION

### Problems to be Solved by the Invention

In a system of digital AV equipment, such as a digital TV or a set-top box (STB), which includes a Chinese character font ROM (mask ROM) for marketing in Japan, a start-up program or a program for a writable ROM may be provided by using a part of the mask ROM.

However, such a font ROM is not needed in a system to be marketed overseas. Therefore, in order to realize a system configuration that only includes the writable ROM, it is necessary to write a program to the writable ROM in advance or to provide a dedicated downloading contact on the set substrate on which the writable ROM is mounted, as described above, resulting in an increase in the production cost. Moreover, since the dedicated downloading contact will not particularly be needed after the substrate is made into a product, it is preferred to avoid providing the dedicated downloading contact if possible.

The present invention, which has been made in view of the above, has an object to make is possible to download a necessary program to a blank writable ROM mounted on the substrate without suppressing the cost increase.

### Means for Solving the Problems

Specifically, the present invention is directed to a memory writing device for writing a program to be executed by a CPU in a blank writable ROM mounted on a substrate, comprising:

a memory card I/F device for reading the program, which is pre-recorded on an external memory card;

a CPU start-up control section for suppressing and controlling start-up of the CPU; and

a DMA device for transferring, in a DMA transfer, the program read by the memory card I/F device before the start-up of the CPU.

### Effects of the Invention

As described above, according to the present invention, it is no longer necessary to provide a special jig, or to provide a dedicated downloading contact on the set substrate on which the writable ROM is mounted. Thus, by downloading a program to a blank writable ROM by using a memory card I/F, such as an SD memory card, which is normally provided in a set system, it is possible to provide a memory writing device for programming a writable ROM when shipping the set product, thus realizing advantageous effects in reducing the cost for providing a program in a writable ROM in advance or the cost for a substrate.

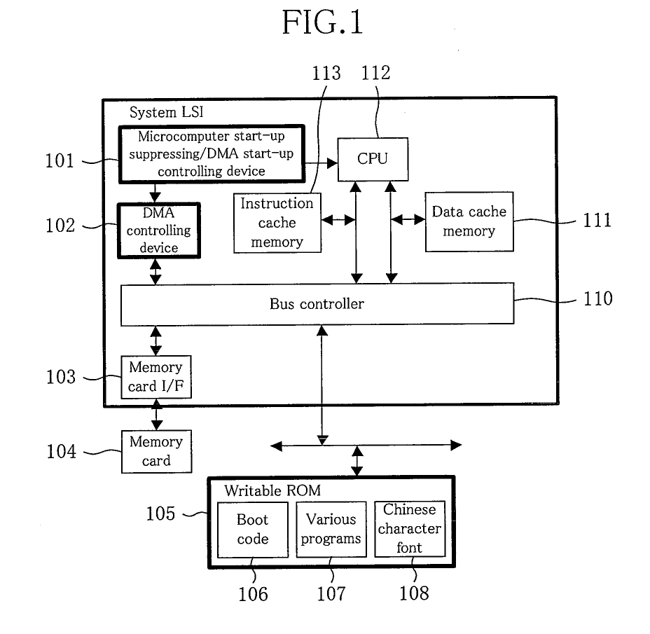

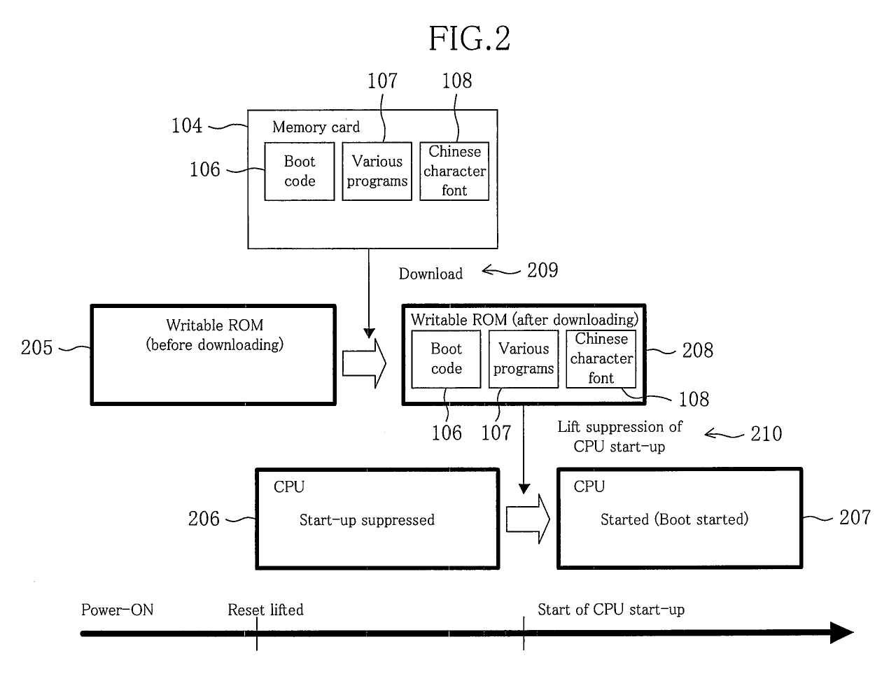

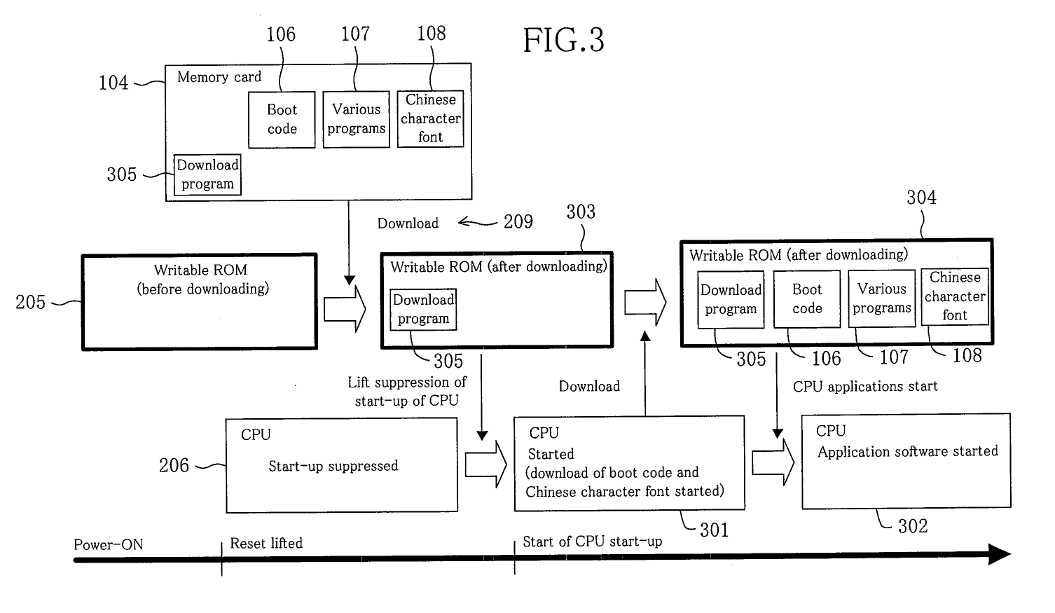

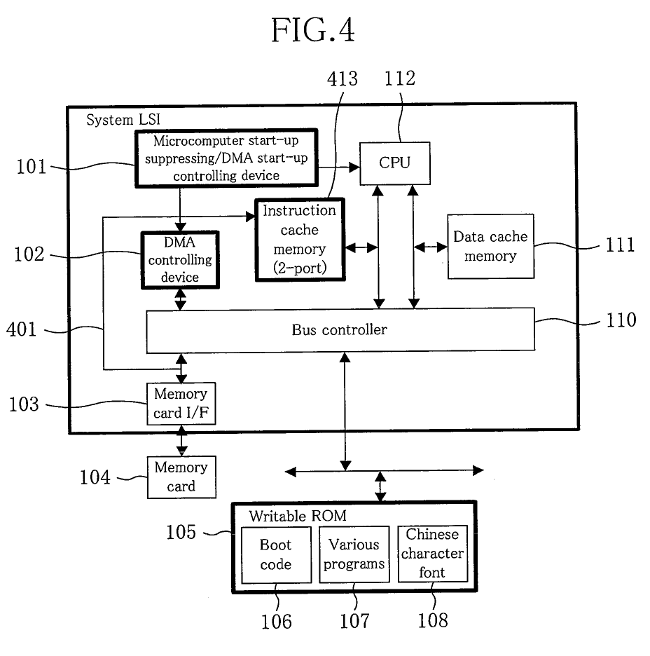

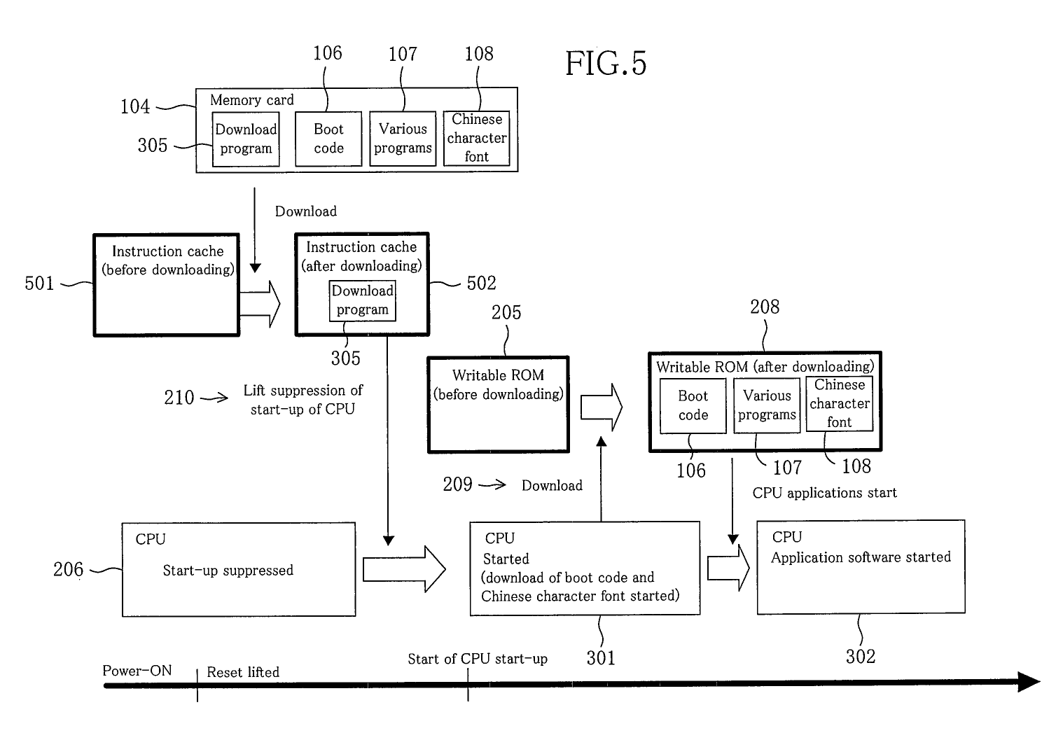

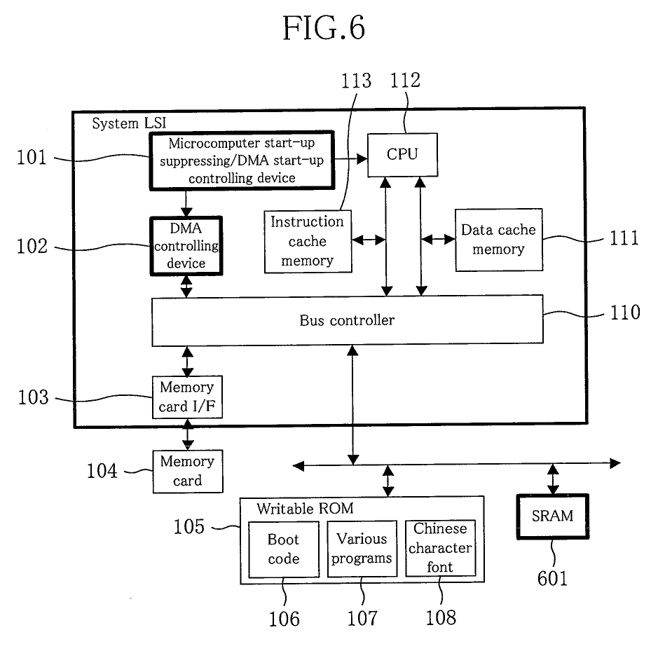

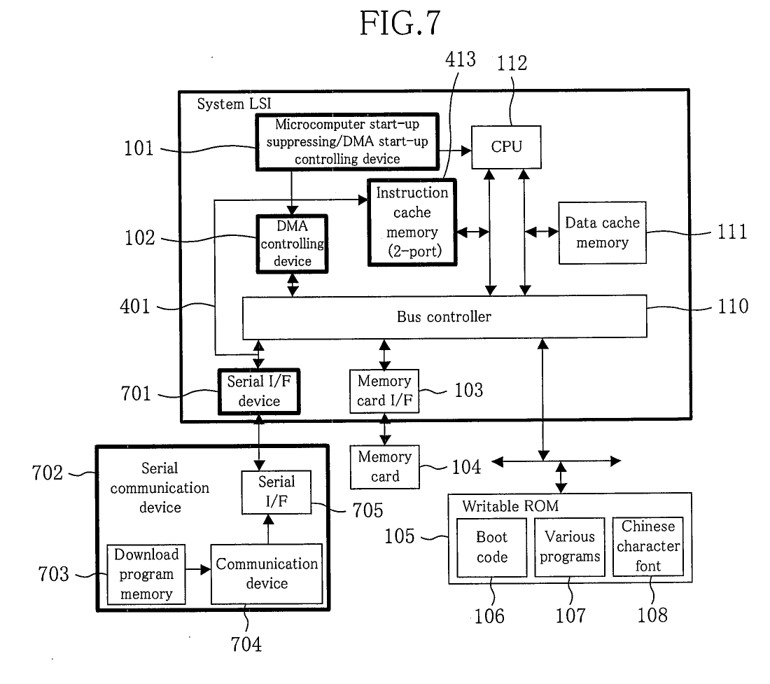

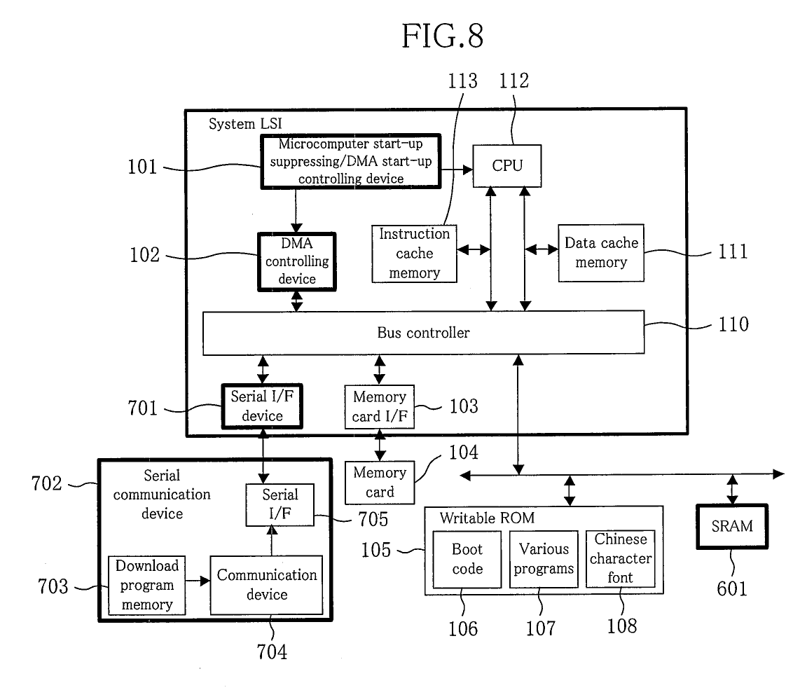

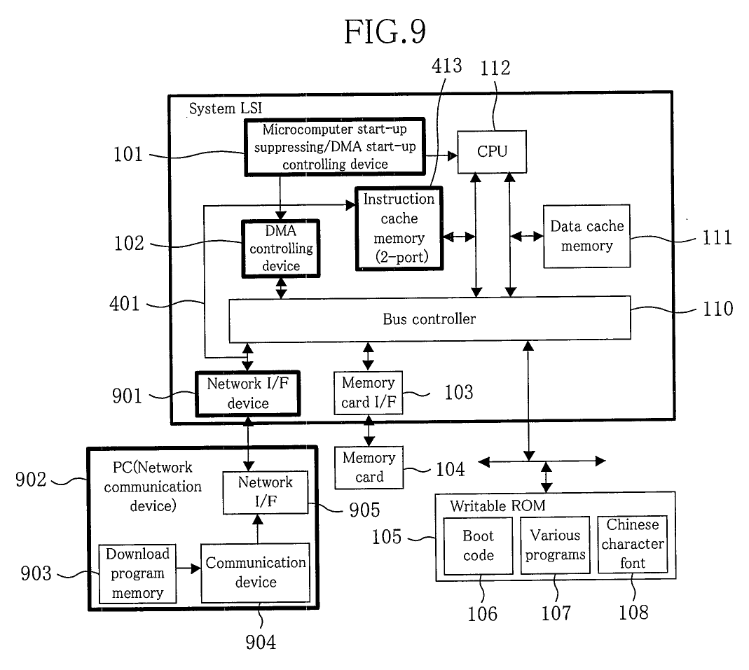

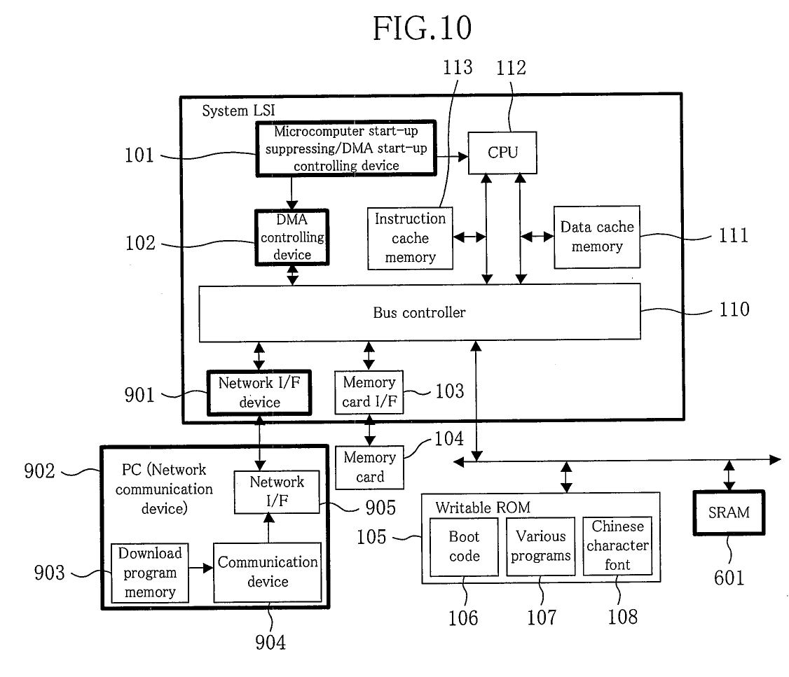

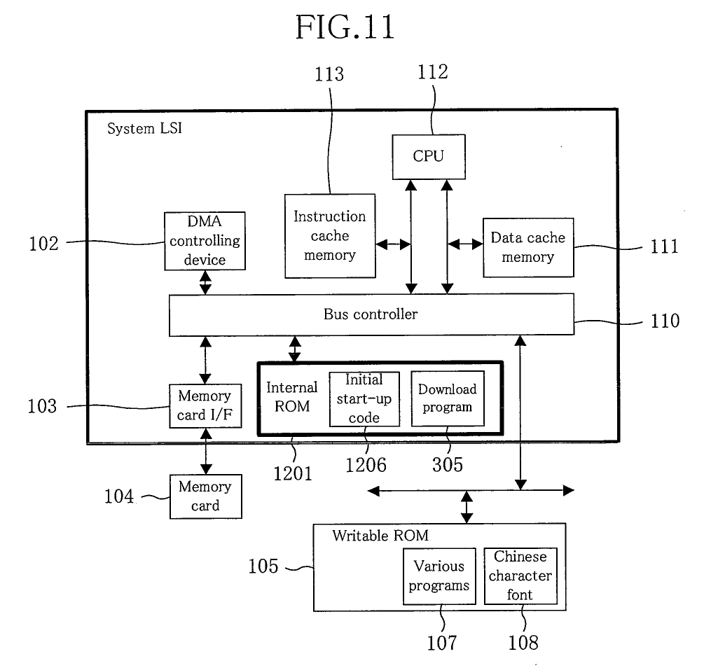

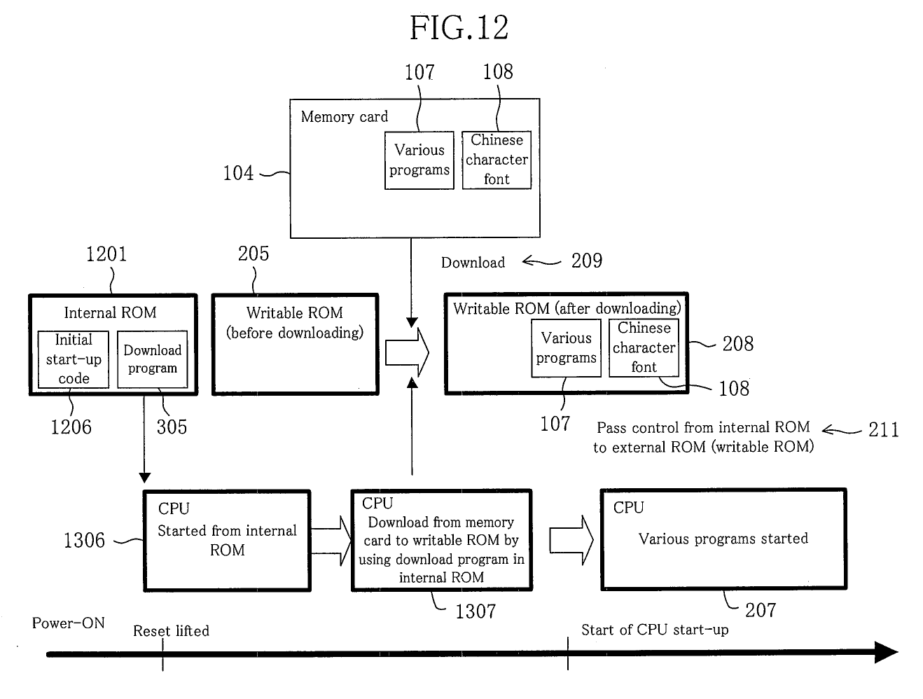

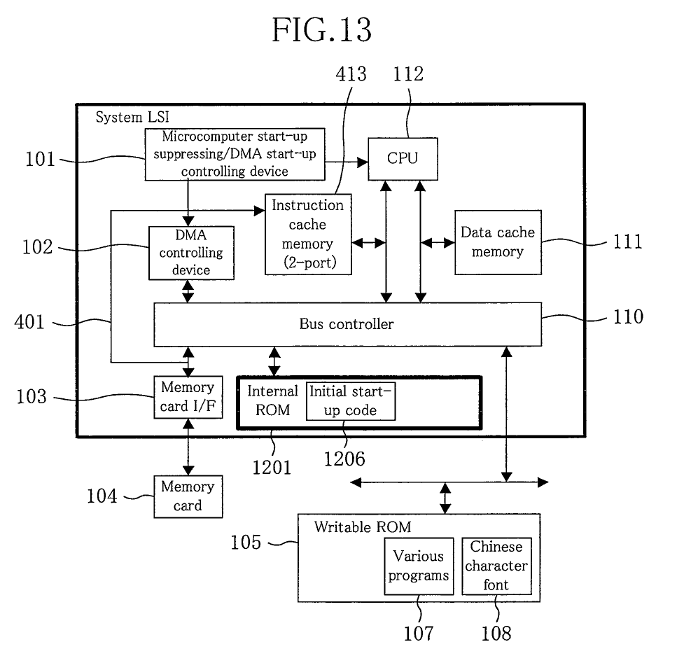

### BRIEF DESCRIPTION OF THE DRAWINGS

[FIG. 1] FIG. 1 is a block diagram showing a configuration of a memory writing device according to Embodiment 1 of the present invention.

[FIG. 2] FIG. 2 is a diagram showing a procedure of writing a program by using a memory writing device of Embodiment 1.

[FIG. 3] FIG. 3 is a block diagram showing a configuration of a memory writing device of Embodiment 2.

[FIG. 4] FIG. 4 is a block diagram showing a configuration of a memory writing device of Embodiment 3.

[FIG. 5] FIG. 5 is a diagram showing a procedure of writing a program by using the memory writing device of Embodiment 3.

[FIG. 6] FIG. 6 is a block diagram showing a configuration of a memory writing device of Embodiment 4.

[FIG. 7] FIG. 7 is a block diagram showing a configuration of a memory writing device of Embodiment 5.

[FIG. 8] FIG. 8 is a block diagram showing a configuration of a memory writing device of Embodiment 6.

[FIG. 9] FIG. 9 is a block diagram showing a configuration of a memory writing device of Embodiment 7.

[FIG. 10] FIG. 10 is a block diagram showing a configuration of a memory writing device of Embodiment 8.

[FIG. 11] FIG. 11 is a block diagram showing a configuration of a memory writing device of Embodiment 9.

[FIG. 12] FIG. 12 is a diagram showing a procedure of writing a program by using the memory writing device of Embodiment 9.

[FIG. 13] FIG. 13 is a block diagram showing a configuration of a memory writing device of Embodiment 10.

### DESCRIPTION OF REFERENCE NUMERALS

101 Microcomputer start-up suppressing/DMA start-up controlling device
102 DMA controlling device
104 External memory card
105 Writable ROM
112 CPU
113 Instruction cache memory
401 Data path
601 SRAM device
701 Serial I/F device
702 Serial communication device
703 Download program memory
704 Communication device
705 Serial I/F
901 Network I/F device
902 Network communication device
903 Download program memory
904 Communication device
905 Network I/F
1201 Internal ROM

### MODE FOR CARRYING OUT THE INVENTION

Embodiments of the present invention will now be described with reference to the drawings. The following description of the preferred embodiments of the present invention is merely illustrative in nature, and is in no way intended to restrict the present invention, applications or usage thereof.

### Embodiment 1

FIG. 1 is a block diagram showing a configuration of a memory writing device according to Embodiment 1 of the present invention. The memory writing device of FIG. 1 includes a microcomputer start-up suppressing/DMA start-up controlling device 101, a DMA controlling device 102, a memory card I/F 103 for exchanging data with an inserted external memory card 104, a bus controller 110 for performing a control so as to transfer data read out by the memory card I/F 103 to a writable ROM 105, a data cache memory 111, a CPU 112 for executing instructions, and an instruction cache memory 113.

The microcomputer start-up suppressing/DMA start-up controlling device 101 is a device for suppressing the start-up of the CPU 112 and instructing the DMA controlling device 102 to start up a DMA process.

The DMA controlling device 102 is a device for transferring necessary programs, such as a start-up program and application programs, recorded on the external memory card 104.

Although a boot-up program (BOOT code) 106, various programs 107 and Chinese character font data 108 are already written in the writable ROM 105 in FIG. 1, the writable ROM 105 is initially in a blank state.

Next, a procedure of writing a program by using the memory writing device of Embodiment 1 will be described with reference to FIG. 2.

First, when the power is turned ON and the reset is lifted after power-on, the CPU 112 enters a state 206 where the start-up thereof is suppressed by the microcomputer start-up suppressing/DMA start-up controlling device 101. At this point, the inside of the writable ROM 105, which is arranged in an address space from which the start-up program of the CPU 112 should be read out, is in a blank state 205 where the start-up program has not been written therein.

Next, the microcomputer start-up suppressing/DMA start-up controlling device 101 instructs the DMA controlling device 102 to start up a DMA process to thereby start a download 209 of the start-up program.

Herein, a read address and a write address need to be initialized in the DMA controlling device 102 for a data transfer from the external memory card 104, in which necessary programs such as a start-up program and application programs are written in advance, to the writable ROM 105.

After the DMA controlling device 102 starts up, data is transferred from the external memory card 104 to the writable ROM 105, and the writable ROM 105 enters a state 208 where the boot-up program 106, the various programs 107 and the Chinese character font data 108 have been transferred thereto.

When the data transfer is complete, the DMA controlling device 102 notifies the microcomputer start-up suppressing/DMA start-up controlling device 101 of the completion of the data transfer. Then, the microcomputer start-up suppressing/DMA start-up controlling device 101 lifts 210 the suppression of the start-up of the CPU 112, thereby entering a state 207 where the boot-up of the CPU 112 has started, after which the process transitions to a state where application software has been started.

### Embodiment 2

FIG. 3 is a diagram showing a procedure of writing a program by using the memory writing device according to Embodiment 2 of the present invention. It is assumed that the memory writing device used in Embodiment 2 is the same as that of Embodiment 1. Hereinafter, like elements to those of Embodiment 1 will be denoted by like reference numerals, and only differences between these embodiments will be discussed below.

First, when the power is turned ON and the reset is lifted after power-on, the CPU 112 enters a state 206 where the start-up thereof is suppressed by the microcomputer start-up suppressing/DMA start-up controlling device 101. At this point, the inside of the writable ROM 105, which is arranged in an address space from which the start-up program of the CPU 112 should be read out, is in a blank state 205 where the start-up program has not been written therein.

Next, the microcomputer start-up suppressing/DMA start-up controlling device 101 instructs the DMA controlling device 102 to start up a DMA process to thereby start the download 209 of the start-up program.

Herein, a read address and a write address need to be initialized in the DMA controlling device 102 for a data transfer from the external memory card 104, in which necessary programs such as a start-up program and application programs are written in advance, to the writable ROM 105. In this process, the DMA controlling device 102 is set so as to transfer only a download program 305.

After the DMA controlling device 102 starts up, data is transferred from the external memory card 104 to the writable ROM 105, and the writable ROM 105 enters a state 303 where only the download program 305 has been transferred thereto.

When the data transfer is complete, the DMA controlling device 102 notifies the microcomputer start-up suppressing/DMA start-up controlling device 101 of the completion of the data transfer. Then, the microcomputer start-up suppressing/DMA start-up controlling device 101 lifts 210 the suppression of the start-up of the CPU 112, thereby entering a state 301 where the start-up of the CPU 112 has started.

Then, based on the download program 305 written in the writable ROM 105, the CPU 112 itself reads out the boot-up program 106, the various programs 107 and the Chinese character font data 108, which are stored in the external memory card 104, and transfers them to the writable ROM 105, thus entering a state 304 where necessary data have been written in the writable ROM 105.

When the data transfer to the writable ROM 105 is complete, the CPU 112 passes the control back to the boot-up program, thus entering a state where the boot-up has started, after which the process transitions to a state 302 where application software has been started.

### Embodiment 3

FIG. 4 is a block diagram showing a configuration of a memory writing device according to Embodiment 3 of the present invention. A difference from Embodiment 1 is that a data path for transferring data read out by the memory card I/F to a 2-port instruction cache memory is provided. Hereinafter, like elements to those of Embodiment 1 will be denoted by like reference numerals, and only differences between these embodiments will be discussed below.

As shown in FIG. 4, reference numeral 413 denotes a 2-port-control instruction cache memory, to/from which data can be written/read out by the CPU 112 and to which data can be written by the DMA controlling device 102. The instruction cache memory 413 is connected to the memory card I/F 103 via a data path 401, whereby data read out by the memory card I/F 103 is transferred thereto.

Next, a procedure of writing a program by using the memory writing device of Embodiment 3 will be described with reference to FIG. 5.

First, when the power is turned ON and the reset is lifted after power-on, the CPU 112 enters a state 206 where the start-up thereof is suppressed by the microcomputer start-up suppressing/DMA start-up controlling device 101. At this point, the inside of the writable ROM 105, which is arranged in an address space from which the start-up program of the CPU 112 should be read out, is in a blank state 205 where the start-up program has not been written therein. The instruction cache memory 413 is similarly in a blank state 501.

Next, the microcomputer start-up suppressing/DMA start-up controlling device 101 instructs the DMA controlling device 102 to start up a DMA process to thereby start the download 209 of the start-up program.

Herein, a read address and a write address need to be initialized in the DMA controlling device 102 for a data transfer from the external memory card 104, in which necessary programs such as a start-up program and application programs are written in advance, to the instruction cache memory 113. In this process, the DMA controlling device 102 is set so as to transfer only a download program 305.

After the DMA controlling device 102 starts up, data is transferred from the external memory card 104 to the instruction cache memory 413 via the data path 401, and the instruction cache memory 413 enters a state 502 where only the download program 305 has been transferred thereto.

When the data transfer to the instruction cache memory 113 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts 210 the suppression of the start-up of the CPU 112, thereby entering the state 301 where the start-up of the CPU 112 has started.

Then, based on the download program 305 written in the instruction cache memory 413, the CPU 112 itself reads out the boot-up program 106, the various programs 107 and the Chinese character font data 108, which are stored in the external memory card 104, and transfers them to the writable ROM 105, thus entering a state 208 where necessary data have been written in the writable ROM 105.

When the data transfer to the writable ROM 105 is complete, the CPU 112 passes the control back to the boot-up program, thus entering a state where the boot-up has started, after which the process transitions to the state 302 where application software has been started.

### Embodiment 4

FIG. 6 is a block diagram showing a configuration of a memory writing device according to Embodiment 4 of the present invention. A difference from Embodiment 1 is that an SRAM device is provided. Hereinafter, like elements to those of Embodiment 1 will be denoted by like reference numerals, and only differences between these embodiments will be discussed below.

As shown in FIG. 6, an SRAM device 601 is connected to the bus controller 110 and is configured so that data can be written thereto by the DMA controlling device 102.

Next, a procedure of writing a program by using the memory writing device of Embodiment 4 will be described.

First, when the power is turned ON and the reset is lifted after power-on, the CPU 112 enters a state where the start-up thereof is suppressed by the microcomputer start-up suppressing/DMA start-up controlling device 101. At this point, the inside of the SRAM device 601, which is arranged in an address space from which the start-up program of the CPU 112 should be read out, is in a blank state where the start-up program has not been written therein. The writable ROM 105 arranged in a different space is similarly in a blank state.

Next, the microcomputer start-up suppressing/DMA start-up controlling device 101 instructs the DMA controlling device 102 to start up a DMA process to thereby start a download of the start-up program.

Herein, a read address and a write address need to be initialized in the DMA controlling device 102 for a data transfer from the external memory card 104, in which necessary programs such as a start-up program and application programs are written in advance, to the SRAM device 601. In this process, the DMA controlling device 102 is set so as to transfer only the download program 305.

After the DMA controlling device 102 starts up, data is transferred from the external memory card 104 to the SRAM device 601, and the SRAM device 601 enters a state where only the download program 305 has been transferred thereto.

When the data transfer to the SRAM device 601 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts the suppression of the start-up of the CPU 112, thereby entering a state where the start-up of the CPU 112 has started.

Then, based on the download program 305 written in the SRAM device 601, the CPU 112 itself reads out the boot-up program 106, the various programs 107 and the Chinese character font data 108, which are stored in the external memory card 104, and transfers them to the writable ROM 105, thus entering a state where necessary data have been written in the writable ROM 105.

When the data transfer to the writable ROM 105 is complete, the CPU 112 passes the control back to the boot-up program, thus entering a state where the boot-up has started, after which the process transitions to a state where application software has been started.

### Embodiment 5

FIG. 7 is a block diagram showing a configuration of a memory writing device of Embodiment 5. A difference from Embodiment 1 is that a serial communication device is provided. Hereinafter, like elements to those of Embodiment 1 will be denoted by like reference numerals, and only differences between these embodiments will be discussed below.

As shown in FIG. 7, reference numeral 702 denotes a serial communication device, including a download program memory 703 for storing the download program, and a communication device 704 for transferring the download program via a serial I/F 705.

Reference numeral 701 denotes a serial I/F device for data communications with the serial communication device 702. The download program transmitted from the serial communication device 702 via the serial I/F device 701 is written in the instruction cache memory 413 via the data path 401.

Next, a procedure of writing a program by using the memory writing device of Embodiment 5 will be described.

First, when the power is turned ON and the reset is lifted after power-on, the CPU 112 enters a state where the start-up thereof is suppressed by the microcomputer start-up suppressing/DMA start-up controlling device 101. At this point, the inside of the instruction cache memory 413, which is arranged in an address space from which the start-up program of the CPU 112 should be read out, is in a blank state where the start-up program has not been written therein. The writable ROM 105 is similarly in a blank state.

Next, the microcomputer start-up suppressing/DMA start-up controlling device 101 instructs the DMA controlling device 102 to start up a DMA process to thereby start a download of the start-up program.

Herein, a read address and a write address need to be initialized in the DMA controlling device 102 for a data transfer from the receiving data buffer of the serial I/F device 701 to the instruction cache memory 413.

The serial I/F device 701 is such that a program on the download program memory 703 in the externally-connected serial communication device 702 is transferred thereto via the communication device 704 and the serial I/F 705, and the DMA controlling device 102 is set so as to transfer only the download program 305.

After the DMA controlling device 102 starts up, data is transferred from the serial I/F device 701 to the instruction cache memory 413 via the data path 401, and the instruction cache memory 413 enters a state where only the download program 305 has been transferred thereto.

When the data transfer to the instruction cache memory 413 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts the suppression of the start-up of the CPU 112, thereby entering a state where the start-up of the CPU 112 has started.

Then, based on the download program 305 written in the instruction cache memory 413, the CPU 112 itself reads out the boot-up program 106, the various programs 107 and the Chinese character font data 108, which are stored in the external memory card 104, and transfers them to the writable ROM 105, thus entering a state where necessary data have been written in the writable ROM 105.

When the data transfer to the writable ROM 105 is complete, the CPU 112 passes the control back to the boot-up program, thus entering a state where the boot-up has started, after which the process transitions to a state where application software has been started.

### Embodiment 6

FIG. 8 is a block diagram showing a configuration of a memory writing device according to Embodiment 6 of the present invention. A difference from Embodiment 5 is that an SRAM device is provided additionally. Hereinafter, like elements to those of Embodiment 5 will be denoted by like reference numerals, and only differences between these embodiments will be discussed below.

As shown in FIG. 8, the SRAM device 601 is connected to the bus controller 110 and is configured so that data can be written thereto by the DMA controlling device 102.

Next, a procedure of writing a program by using the memory writing device of Embodiment 6 will be described.

First, when the power is turned ON and the reset is lifted after power-on, the CPU 112 enters a state where the start-up thereof is suppressed by the microcomputer start-up suppressing/DMA start-up controlling device 101. At this point, the inside of the SRAM device 601, which is arranged in an address space from which the start-up program of the CPU 112 should be read out, is in a blank state where the start-up program has not been written therein. The writable ROM 105 arranged in a different space is similarly in a blank state.

Next, the microcomputer start-up suppressing/DMA start-up controlling device 101 instructs the DMA controlling device 102 to start up a DMA process to thereby start a download of the start-up program.

Herein, a read address and a write address need to be initialized in the DMA controlling device 102 for a data transfer from the receiving data buffer of the serial I/F device 701 to the instruction cache memory 113.

The serial I/F device 701 is such that a program on the download program memory 703 in the externally-connected serial communication device 702 is transferred thereto via the communication device 704 and the serial I/F 705, and the DMA controlling device 102 is set so as to transfer only the download program 305.

After the DMA controlling device 102 starts up, data is transferred from the serial I/F device 701 to the SRAM device 601, and the SRAM device 601 enters a state where only the download program 305 has been transferred thereto.

When the data transfer to the SRAM device 601 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts the suppression of the start-up of the CPU 112, thereby entering a state where the start-up of the CPU 112 has started.

Then, based on the download program 305 written in the SRAM device 601, the CPU 112 itself reads out the boot-up program 106, the various programs 107 and the Chinese character font data 108, which are stored in the external memory card 104, and transfers them to the writable ROM 105, thus entering a state where necessary data have been written in the writable ROM 105.

When the data transfer to the writable ROM 105 is complete, the CPU 112 passes the control back to the boot-up program, thus entering a state where the boot-up has started, after which the process transitions to a state where application software has been started.

### Embodiment 7

FIG. 9 is a block diagram showing a configuration of a memory writing device according to Embodiment 7 of the present invention. A difference from Embodiment 1 is that a network communication device is provided. Hereinafter, like elements to those of Embodiment 1 will be denoted by like reference numerals, and only differences between these embodiments will be discussed below.

As shown in FIG. 9, reference numeral 902 is a network communication device being a personal computer, or the like, including a download program memory 903 for storing a download program, and a communication device 904 for transferring the download program via a network I/F 905.

Reference numeral 901 denotes a network I/F device for data communications with the network communication device 902. The download program transmitted from the network communication device 902 via the network I/F device 901 is written in the instruction cache memory 413 via the data path 401.

Next, a procedure of writing a program by using the memory writing device of Embodiment 7 will be described.

First, when the power is turned ON and the reset is lifted after power-on, the CPU 112 enters a state where the start-up thereof is suppressed by the microcomputer start-up suppressing/DMA start-up controlling device 101. At this point, the inside of the instruction cache memory 413, which is arranged in an address space from which the start-up program of the CPU 112 should be read out, is in a blank state where the start-up program has not been written therein. The writable ROM 105 is similarly in a blank state.

Next, the microcomputer start-up suppressing/DMA start-up controlling device 101 instructs the DMA controlling device 102 to start up a DMA process to thereby start a download of the start-up program.

Herein, a read address and a write address need to be initialized in the DMA controlling device 102 for a data transfer from the receiving data buffer of the network I/F device 901 to the instruction cache memory 413.

The network I/F device 901 is such that a program on the download program memory 903 in the externally-connected network communication device 902 is transferred thereto via the communication device 904 and the network I/F 905, and the DMA controlling device 102 is set so as to transfer only the download program 305.

After the DMA controlling device 102 starts up, data is transferred from the network I/F device 901 to the instruction cache memory 413 via the data path 401, and the instruction cache memory 413 enters a state where only the download program 305 has been transferred thereto.

When the data transfer to the instruction cache memory 413 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts the suppression of the start-up of the CPU 112, thereby entering a state where the start-up of the CPU 112 has started.

Then, based on the download program 305 written in the instruction cache memory 413, the CPU 112 itself reads out the boot-up program 106, the various programs 107 and the Chinese character font data 108, which are stored in the external memory card 104, and transfers them to the writable ROM 105, thus entering a state where necessary data have been written in the writable ROM 105.

When the data transfer to the writable ROM 105 is complete, the CPU 112 passes the control back to the boot-up program, thus entering a state where the boot-up has started, and the process transitions to a state where application software has been started.

### Embodiment 8

FIG. 10 is a block diagram showing a configuration of a memory writing device according to Embodiment 8 of the present invention. A difference from Embodiment 7 is that an SRAM device is provided additionally. Hereinafter, like elements to those of Embodiment 7 will be denoted by like reference numerals, and only differences between these embodiments will be discussed below.

As shown in FIG. 10, the SRAM device 601 is connected to the bus controller 110 and is configured so that data can be written thereto by the DMA controlling device 102.

Next, a procedure of writing a program by using the memory writing device of Embodiment 8 will be described.

First, when the power is turned ON and the reset is lifted after power-on, the CPU 112 enters a state where the start-up thereof is suppressed by the microcomputer start-up suppressing/DMA start-up controlling device 101. At this point, the inside of the SRAM device 601, which is arranged in an address space from which the start-up program of the CPU 112 should be read out, is in a blank state where the start-up program has not been written therein. The writable ROM 105 arranged in a different space is similarly in a blank state.

Next, the microcomputer start-up suppressing/DMA start-up controlling device 101 instructs the DMA controlling device 102 to start up a DMA process to thereby start a download o f the start-up program.

Herein, a read address and a write address need to be initialized in the DMA controlling device 102 for a data transfer from the receiving data buffer of the network I/F device 901 to the instruction cache memory 113.

The network I/F device 901 is such that a program on the download program memory 903 in the externally-connected network communication device 902 is transferred thereto via the communication device 904 and the network I/F 905, and the DMA controlling device 102 is set so as to transfer only the download program 305.

After the DMA controlling device 102 starts up, data is transferred from the network I/F device 901 to the SRAM device 601, and the SRAM device 601 enters a state where only the download program 305 has been transferred thereto.

When the data transfer to the SRAM device 601 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts the suppression of the start-up of the CPU 112, thereby entering a state where the start-up of the CPU 112 has started.

Then, based on the download program 305 written in the SRAM device 601, the CPU 112 itself reads out the boot-up program 106, the various programs 107 and the Chinese character font data 108, which are stored in the external memory card 104, and transfers them to the writable ROM 105, thus entering a state where necessary data have been written in the writable ROM 105.

When the data transfer to the writable ROM 105 is complete, the CPU 112 passes the control back to the boot-up program, thus entering a state where the boot-up has started, and the process transitions to a state where application software has been started.

### Embodiment 9

FIG. 11 is a block diagram showing a configuration of a memory writing device according to Embodiment 9 of the present invention. The memory writing device of FIG. 11 includes the DMA controlling device 102, the memory card I/F 103 for exchanging data with the inserted external memory card 104, the bus controller 110 for performing a control so as to transfer data read out by the memory card I/F 103 to the writable ROM 105, the data cache memory 111, the CPU 112 for executing instructions, the instruction cache memory 113, and an internal ROM 1201 connected to the bus controller 110.

The DMA controlling device 102 is a device for transferring necessary programs, such as a start-up program and application programs, recorded on the external memory card 104.

Although the various programs 107 and the Chinese character font data 108 are already written in the writable ROM 105 in FIG. 11, the writable ROM 105 is initially in a blank state.

An initial start-up program 1206 (initial start-up code) and the download program 305 are stored in the internal ROM 1201.

Next, a procedure of writing a program by using the memory writing device of Embodiment 9 will be described with reference to FIG. 12.

First, when the power is turned ON and the reset is lifted after power-on, the CPU 112 enters a state 1306 where the start-up thereof has been started by the initial start-up program 1206 stored in the internal ROM 1201 arranged in an address space from which the start-up program of the CPU 112 should be read out.

Then, based on the download program 305 stored in the internal ROM 1201, the CPU 112 itself, whose initial start-up has been started, reads out the various programs 107 and the Chinese character font data 108, which are stored in the external memory card 104, and starts transferring 1307 them to the writable ROM 105. Thus, the process enters a state 208 where necessary data have been written in the writable ROM 105.

When the data transfer to the writable ROM 105 is complete, the CPU 112 passes the control from the internal ROM 1201 to the writable ROM 105, and enters a state 207 where application software has been started.

In order to pass the control from the internal ROM 1201 to the writable ROM 105 immediately after the completion of the download, the download program 305 needs to be so programmed in advance.

### Embodiment 10

FIG. 13 is a block diagram showing a configuration of a memory writing device according to Embodiment 10 of the present invention. A difference from Embodiment 3 is that the internal ROM 1201 is provided. Hereinafter, like elements to those of Embodiment 3 will be denoted by like reference numerals, and only differences between these embodiments will be discussed below.

As shown in FIG. 13, the initial start-up program 1206 (initial start-up code) is stored in the internal ROM 1201.

Although the various programs 107 and the Chinese character font data 108 are already written in the writable ROM 105 in FIG. 13, the writable ROM 105 is initially in a blank state.

Next, a procedure of writing a program by using the memory writing device of Embodiment 10 will be described.

First, when the power is turned ON and the reset is lifted after power-on, the CPU 112 enters a state where the start-up thereof is suppressed by the microcomputer start-up suppressing/DMA start-up controlling device 101. At this point, the inside of the writable ROM 105 is in a blank state where programs to be read out have not been written therein. The instruction cache memory 413 is similarly in a blank state.

Next, the microcomputer start-up suppressing/DMA start-up controlling device 101 instructs the DM NA controlling device 102 to start up a DMA process.

Herein, a read address and a write address need to be initialized in the DMA controlling device 102 for a data transfer from the external memory card 104, in which necessary programs such as the download program 305 and application programs are written in advance, to the instruction cache memory 113. In this process, the DMA controlling device 102 is set so as to transfer only the download program 305.

After the DMA controlling device 102 starts up, data is transferred from the external memory card 104 to the instruction cache memory 413 via the data path 401, and the instruction cache memory 413 enters a state where only the download program 305 has been transferred thereto.

When the data transfer to the instruction cache memory 413 is complete, the DMA controlling device 102 notifies the microcomputer start-up suppressing/DMA start-up controlling device 101 of the completion of the data transfer. Then, the microcomputer start-up suppressing/DMA start-up controlling device 101 lifts the suppression of the start-up of the CPU 112, thereby entering a state where the start-up of the CPU 112 has been started by the initial start-up program 1206 stored in the internal ROM 1201.

Then, based on the download program 305 stored in the instruction cache memory 413, the CPU 112 itself, whose initial start-up has been started, reads out the various programs 107 and the Chinese character font data 108, which are stored in the external memory card 104, and transfers them to the writable ROM 105, thus entering a state where necessary data have been written in the writable ROM 105.

When the data transfer to the writable ROM 105 is complete, the CPU 112 passes the control from the internal ROM 1201 to the writable ROM 105, and then enters a state where application software has been started.

### Embodiment 11

Next, a procedure of writing a program by using the memory writing device of Embodiment 11 will be described. The device configuration of the memory writing device of Embodiment 11 is the same as that of Embodiment 10, and will therefore be described below with reference to FIG. 13.

First, when the power is turned ON and the reset is lifted after power-on, the CPU 112 enters a state where the initial start-up of the CPU 112 has been started by the initial start-up program 1206, which is stored in the internal ROM 1201 arranged in an address space from which the start-up program of the CPU 112 should be read out.

At this point, the inside of the writable ROM 105 is in a blank state where programs to be read out have not been written therein. The instruction cache memory 413 is similarly in a blank state.

Next, the CPU 112, whose initial start-up has been started, initializes the DMA controlling device 102. Specifically, a read address and a write address are initialized for transferring only the download program 305 from the external memory card 104, in which necessary programs such as the download program 305 and application programs are written in advance, to the instruction cache memory 413.

Then, after the initialization of the DMA controlling device 102, the DMA controlling device 102 is instructed to start up a DMA process.

After the DMA controlling device 102 starts up, data is transferred from the external memory card 104 to the instruction cache memory 413 via the data path 401, and the instruction cache memory 413 enters a state where only the download program 305 has been transferred thereto.

When the data transfer to the instruction cache memory 413 is complete, based on the download program 305 written in the instruction cache memory 413, the CPU 112 itself reads out the various programs 107 and the Chinese character font data 108, which are stored in the external memory card 104, and transfers them to the writable ROM 105, thus entering a state where necessary data have been mitten in the writable ROM 105.

When the data transfer to the writable ROM 105 is complete, the CPU 112 passes the control to the writable ROM 105, and then enters a state where application software has been started.

In order to pass the control to the writable ROM 105 immediately after the completion of the download, the download program 305 needs to be so programmed in advance.

### INDUSTRIAL APPLICABILITY

As described above, the present invention is very useful and has a very high industrial applicability because it provides a highly practical effect of making it possible to download necessary programs to a blank writable ROM, which is mounted on the substrate, while suppressing the cost increase.

1. A memory writing device for writing a program to be executed by a CPU in a blank writable ROM mounted on a substrate, comprising:
a memory card I/F device for reading the program, which is pre-recorded on an external memory card;
a CPU start-up control section for suppressing and controlling start-up of the CPU; and
a DMA device for transferring, in a DMA transfer, the program read by the memory card I/F device before the start-up of the CPU.

2. The memory writing device of claim 1, wherein:
the program recorded on the external memory card includes a download program executable by the CPU;
before the start-up of the CPU, only the download program, among other programs, is written in the writable ROM by the DMA device; and
after the start-up of the CPU, the CPU executes the download program, whereby remaining programs recorded on the external memory card are written in the writable ROM.

3. The memory writing device of claim 1, further comprising a 2-port-control cache memory to/from which data can be written/read out by the CPU and to which data can be written by the DMA device, wherein:
the program recorded on the external memory card includes a download program executable by the CPU;
before the start-up of the CPU, only the download program, among other programs, is written in the cache memory by the DMA device; and
after the start-up of the CPU, the CPU executes the download program, whereby remaining programs recorded on the external memory card are written in the writable ROM.

4. The memory writing device of claim 1, further comprising an externally-connected SRAM device, wherein:
the program recorded on the external memory card includes a download program executable by the CPU;
before the start-up of the CPU, only the download program, among other programs, is written in the SRAM device by the DMA device; and
after the start-up of the CPU, the CPU executes the download program, whereby remaining programs recorded on the external memory card are written in the writable ROM.

5. The memory writing device of claim 1, further comprising:
a 2-port-control cache memory to/from which data can be written/read out by the CPU and to which data can be written by the DMA device;
a serial communication device including a memory storing a download program executable by the CPU and a communication device for transmitting the program via a serial I/F; and
a serial I/F device for data communications with the serial communication device, wherein:
before the start-up of the CPU, the download program, transmitted from the serial communication device via the serial I/F device, is written in the cache memory by the DMA device; and
after the start-up of the CPU, the CPU executes the download program, whereby programs recorded on the external memory card are written in the writable ROM.

6. The memory writing device of claim 1, further comprising:
an externally-connected SRAM device;
a serial communication device including a memory storing a download program executable by the CPU and a communication device for transmitting the program via a serial I/F; and
a serial I/F device for data communications with the serial communication device, wherein:
before the start-up of the CPU, the download program, transmitted from the serial communication device via the serial I/F device, is written in the SRAM device by the DMA device; and
after the start-up of the CPU, the CPU executes the download program, whereby programs recorded on the external memory card are written in the writable ROM.

7. The memory writing device of claim 1, further comprising:
a 2-port-control cache memory to/from which data can be written/read out by the CPU and to which data can be written by the DMA device;
a network communication device including a memory storing a download program executable by the CPU and a communication device for transmitting the program via a network I/F; and
a serial I/F device for data communications with the network communication device, wherein:
before the start-up of the CPU, the download program, transmitted from the network communication device via the network I/F device, is written in the cache memory by the DMA device; and
after the start-up of the CPU, the CPU executes the download program, whereby programs recorded on the external memory card are written in the writable ROM.

8. The memory writing device of claim 1, further comprising:
an externally-connected SRAM device;
a network communication device including a memory storing a download program executable by the CPU and a communication device for transmitting the program via a network I/F; and
a serial I/F device for data communications with the network communication device, wherein:
before the start-up of the CPU, the download program, transmitted from the network communication device via the network I/F device, is written in the cache memory by the DMA device; and
after the start-up of the CPU, the CPU executes the download program, whereby programs recorded on the external memory card are written in the writable ROM.

9. A memory writing device for writing a program to be executed by a CPU in a blank writable ROM mounted on a substrate, comprising:
a memory card I/F device for reading the program, which is pre-recorded on an external memory card; and
an internal ROM storing an initial start-up program needed for initial start-up of the CPU and a download program executable by the CPU, wherein:
the CPU is initially started up based on the initial start-up program recorded on the internal ROM; and
after the initial start-up of the CPU, the CPU executes the download program, whereby programs recorded on the external memory card are written in the writable ROM.

10. The memory writing device of claim 3, further comprising an internal ROM storing an initial start-up program needed for initial start-up of the CPU, wherein:
before the start-up of the CPU, only the download program, among other programs, is written in the cache memory by the DMA device;
the CPU is initially started up based on the initial start-up program recorded on the internal ROM; and
after the initial start-up of the CPU, the CPU executes the download program, whereby remaining programs recorded on the external memory card are written in the writable ROM.

11. A memory writing device for writing a program to be executed by a CPU in a blank writable ROM mounted on a substrate, comprising:
a memory card I/F device for reading the program, which is pre-recorded on an external memory card;
a DMA device for transferring, in a DMA transfer, the program read by the memory card I/F device;
a 2-port-control cache memory to/from which data can be written/read out by the CPU and to which data can be written by the DMA device; and
an internal ROM storing an initial start-up program needed for initial start-up of the CPU, wherein:
the program recorded on the external memory card includes a download program executable by the CPU;
the CPU is initially started up based on the initial start-up program recorded on the internal ROM;
after the initial start-up of the CPU, the DMA device is initialized by the CPU, after which the DMA device is started up;
only the download program, among other programs, is written in the cache memory by the DMA device; and
after the start-up of the CPU, the CPU executes the download program, whereby remaining programs recorded on the external memory card are written in the writable ROM.
